(19) United States
(12) Patent Application Publication
(10) Pub. No.: US 2013/0104151 A1
(43) Pub. Date: Apr. 25, 2013

(54) Interface Profiles for Customizing Application Programming Interface Behavior

(71) Applicants: Pauline E. Andrews, Southampton (GB); Dennis L. Plum, Hertfordshire (GB)

(72) Inventors: Pauline E. Andrews, Southampton (GB); Dennis L. Plum, Hertfordshire (GB)

(73) Assignee: INTERNATIONAL BUSINESS MACHINES CORPORATION, Armonk, NY (US)

(21) Appl. No.: 13/280,334

(22) Filed: Oct. 24, 2011

(51) Int. Cl. G06F 3/00

(52) U.S. Cl. 719/328

(57) ABSTRACT

Interface profiles are disclosed which specify at least a portion of the verbs and parameters of an existing application programming interface (“API”), and provide a mechanism for customizing behavior of the API, in response to receiving an invocation using the verb and/or parameter(s). The customizing may comprise altering which code executes, and/or how the code executes. An application that invokes a particular API therefore does not need to be changed, yet additional and/or different processing can be performed responsive to the invocation.

### BACKGROUND

The present invention relates to computing systems, and deals more particularly with techniques that allow customizing the behavior of an application programming interface (“API”) without requiring applications invoking that interface to be changed.

An application programming interface, or “API”, is a well-known concept in computer programming, and refers to a definition of the manner in which a particular application can be invoked, and the output that is provided from the invocation. For example, an API specification generally defines the commands (sometimes called “verbs”) that are recognized by an application and the parameters used on those commands, as well as the parameters returned from the invocation.

### BRIEF SUMMARY

The present invention is directed to customizing API behavior using interface profiles. In one aspect, this comprises: determining, for an API invocation, whether an interface profile specification is applicable for customizing behavior of the invocation; and responsive to determining that the interface profile specification is applicable, applying the interface profile specification to customize the behavior of the invocation. The applied interface profile specification may be located by evaluating each of at least one condition specified in each of at least one interface profile specification and concluding that each evaluated condition in the applied profile interface specification is met. The applied interface profile specification may comprise a request specification and a response specification, and the applying may comprise applying a customization specified in at least one of the request specification and the response specification. The request specification may identify an API command that is selected and at least one action that is to be performed as the customization of the behavior of the identified API command, where at least one of the at least one action may override an existing behavior of the identified API command. The response specification may identify an output parameter of the invocation and at least one action that is to be performed as the customization of the behavior of the identified output parameter, where at least one of the at least one action may override an existing behavior of the identified output parameter. The determining may be performed responsive to at least one of receiving the API invocation and receiving a response from the API invocation.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates the signature for a sample function invocation, and FIG. 2 shows a sample invocation of that function;

FIG. 3 illustrates a sample interface profile which may be used for customizing the behavior of an existing illustrative API, where the function invoked according to FIGS. 1 and 2 forms a part of this API;

FIG. 4 provides a flowchart depicting logic which may be used when implementing an embodiment of the present invention; and

FIG. 5 depicts a data processing system suitable for storing and/or executing program code.

### DETAILED DESCRIPTION

When a software developer codes an application program (hereinafter, “application”) that invokes other software (referred to herein generally as another application, or the “invoked application”), it is necessary for the software developer to know details of the invoked application's API. For example, the developer needs to know what commands or verbs (where the terms “command” and “verb” are used interchangeably herein) can be issued to the invoked application, and the parameters that are to be used on the invocation as well as any parameters that will be returned from the invocation. This results in a dependency by the invoking application on the API of the invoked application.

It may happen that it becomes necessary to alter the behavior of the invoked application, for example by adding new functionality. This presents a problem in how to enable invoking applications to make use of the changed behavior of the invoked application. One way to enable the invoking applications to use this changed behavior is to rewrite all of the invoking applications. This is generally not an acceptable solution, however, because the rewriting may be complex, time-consuming, and quite expensive. Furthermore, in some cases, it may happen that the source code of the invoking applications is not available. An embodiment of the present invention is directed toward customizing the behavior that corresponds to the existing API, such that an invoking application can cause the changed behavior to occur in the invoked application, yet without making changes to the code of the invoking application.

In a first scenario, an embodiment of the present invention allows gaining the benefit of new functionality that is added to an invoked application. In another scenario, an embodiment of the present invention allows an invoking application to adapt to a changed resource definition. In both cases, the code of the invoking application does not need to be changed.

With reference to the second scenario, it is noted that the functionality that executes in response to an API verb often involves some resource. The command might request retrieval of one or more values from the resource, for example. It may happen that the resource definition is changed, such as by adding or changing a property of the resource. If the invoking application continues to use API verbs reflecting the prior definition of the resource, the invoked application could encounter an error situation. For example, if an existing API verb is defined as having two input properties, and a third input property is added, the invoked code may receive invalid and unpredictable input for the third parameter, and/or might generate invalid output as a result. Or, the invocation might simply fail due to the parameter mismatch. Furthermore, the invoking application might fail, or function improperly, if a return parameter that is expected by the invoking application is removed from the output generated by the invocation.

A specification referred to herein as an “interface profile” is disclosed. An interface profile specifies at least a portion of the verbs and parameters of an existing API, and provides a mechanism for altering which code executes, and/or how the code executes, in response to receiving an invocation using the verb and/or parameter(s).

By way of illustrating operation of an embodiment of the present invention, a “CLOSE” command is described herein as an example API verb. For this example command, suppose the existing function that executes in response to the CLOSE command is to close a network connection to a server. (An “existing” behavior or function, as that term is used herein, means behavior that has not been customized using the customization approach disclosed herein.) This command may be invoked by a client in a networking environment, for example, when the client has finished using the connection. Now suppose that it becomes desirable to not actually close the connection, but rather to keep the connection open for use by some subsequently-requesting client. This connection reuse approach may be desired because it avoids the overhead of establishing a new connection, and therefore allows the subsequently-requesting client to begin its communications with the server more quickly. (The term “connection pooling” is sometimes used to refer to this type of reuse scenario, as the connection is thought of as being returned to a collection or “pool” of available connections until it is removed from the pool to service a subsequent request. Note that the invoking application in the example scenario does not need to know that the connection will not actually be closed and will instead be returned to a connection pool, because the invoking application has finished with that connection.)

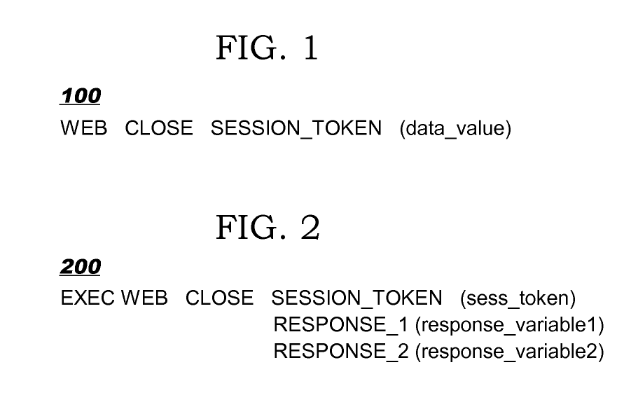

FIG. 1 illustrates a syntax 100 comprising a signature (i.e., invocation pattern) of a sample CLOSE command, indicating that it takes a single invocation parameter named “SESSION_TOKEN”. FIG. 2 illustrates a syntax 200 which may be used, in an invoking application, to invoke the functionality of the CLOSE command. In this sample invocation syntax 200, the keyword “EXEC” indicates that a command execution is requested, the “sess_token” syntax indicates that a session token (which stores an identifier of a session that had been using the connection) is passed as input, the “RESPONSE_1” and “RESPONSE_2” syntax indicates that the CLOSE command returns two output parameters, and the “response_variable1” and “response_variable2” syntax identifies the two variables into which the respective output parameters will be stored.

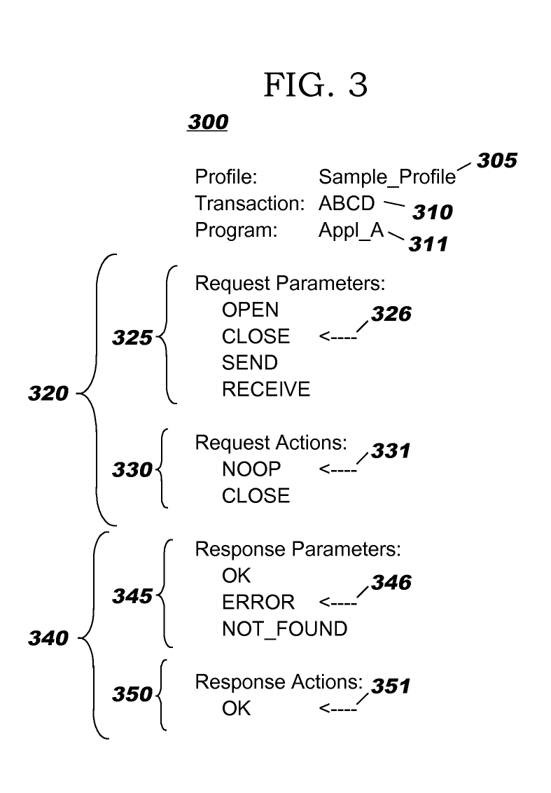

A sample interface profile 300 for an illustrative API is shown in FIG. 3. (It should be noted that the interface profile syntax discussed herein is by way of example only, and different syntax may be used without deviating from the scope of the present invention.) An embodiment of the present invention allows multiple verbs of an API to be specified in a single interface profile, and a selection can then be made as to which of these verbs is to have its behavior customized. Content of the sample interface profile 300 will now be described.

An embodiment of the present invention supports conditionally applying the customization in an interface profile, based on conditions which are preferably identified in the interface profile. In the example scenario, the conditions comprise the transaction which is being executed and the application which invokes the API during the processing of that transaction. Accordingly, for the interface profile named “Sample_Profile” (see 305), the customization defined in this profile is to apply only when an application named “Appl_A” (see 311) invokes this API while processing a transaction having identifier “ABCD” (see 310). All other invocations that do not meet the conditions specified at 310, 311 will use the normal (i.e., non-customized) behavior corresponding to the API, unless a different interface profile is defined which is applicable to those invocations.

Note that an interface profile may specify more than one entry for the values of Transaction 310 and Program 311, although this has not been illustrated in FIG. 3. The Program 311 entry, for example, might be specified as “Appl_A, Appl_B, Appl_C” to indicate that the customization applies to invocations received from any of the applications in the list. Furthermore, a wildcard approach may be supported, whereby absence of an entry at 310 and/or 311 is interpreted as matching that condition for all transactions and all applications, respectively. So, for example, if the sample profile 305 specified “ABCD” at 310 but had no value specified at 311, this would be interpreted as applying the profile 305 to any application that invokes this API when executing transaction “ABCD”.

It should also be noted that the conditions “Transaction” and “Program” are illustrative but not limiting of an embodiment of the present invention. An interface profile may support additional or different parameters to identify the conditions under which the interface profile is to be applied.

An interface profile as disclosed herein preferably comprises a section for customizing input, and well as a section for customizing output. This is shown in the sample interface profile 300 as a request section 320 and a response section 340. A particular interface specification may specify customization in the request section 320, the response section 340, or both. The request section 320 provides a “Request Parameters” section 325 and a “Request Actions” section 330, and the response section 340 provides a “Response Parameters” section 345 and a “Response Actions” section 350. Each of these will now be discussed in more detail.

Request Parameters section 325 contains a list of one or more verbs of the API. In the general case, this section of the interface profile provides a set of verbs that can be overridden to provide customized behavior of an invoked API command. In this example, the list at 325 contains 4 verbs, namely OPEN, CLOSE, SEND, and RECEIVE, and one of the listed verbs has been selected for customizing in the sample interface profile 300. As discussed above, the CLOSE verb is chosen for customizing in this example scenario, such that rather than performing the existing functionality of closing the network connection in response to a request from a client application, the connection will not actually be closed when the client invokes the CLOSE command 200 shown in FIG. 2. A syntax “<- - - -” is used in FIG. 3 to point to the CLOSE verb, thus indicating that this is the command selected for customized behavior. See reference number 326.

As will be obvious, the selection syntax at 326 is merely illustrative. A graphical user interface may be provided for entry of information in an interface profile, and the selectable choices—such as the 4 verbs shown at 325—may be offered to a software developer from such graphical user interface. Radio buttons or another selection mechanism might be used, for example, and the developer's selection can then be stored in association with the sections 325, 330, 345, 350 of profile 300.

Request Actions section 330 contains selectable choices for the desired behavior for the selected verb. In the general case, the Request Actions list 330 provides a set of actions that can be chosen as the behavior of the invoked API command selected in the Request Parameters section 325, to be executed instead of the previously existing, also referred to herein as “normal”, behavior of the selected command. Thus, for the example shown in FIG. 3, the choices are to perform a NOOP (i.e., a null or empty operation, meaning that “no operation” will be performed) or to perform the conventional CLOSE operation. If the CLOSE choice is selected in the example scenario, then the existing CLOSE command is carried out in the normal manner. However, if the NOOP choice is selected, then the CLOSE processing is bypassed. In the example, the NOOP choice is selected, as shown by the syntax at 331.

As another option to selecting between executing the normal function and no processing (i.e., a NOOP), a request action might specify that completely different processing is be invoked. In the example scenario, new code may have been written for connection pooling, and an action such as “CLOSE_to_POOL” might be selected at 330 to cause this new code to be executed in response to an invocation of the CLOSE command.

As another example, if the SEND verb is selected at 325, for example, the Request Action choices presented at 330 might include SEND (referring to the normal action), SEND_with_ACKNOWLEDGEMENT, SEND_with_CC, and so forth, where the second and third choices could be selected to cause execution of operations that perform the send and that also perform some type of acknowledgement processing or that also send a “carbon copy” of the information to one or more other recipients, respectively. As another example, the Request Action section might be used to specify that particular recovery code, or diagnostic code, should be invoked instead of—or in addition to—the normal processing for an invoked API verb.

Response Parameters section 345 contains a list of one or more output parameters of the selected API verb. In the general case, this section of the interface profile provides a set of verbs that can be overridden to provide customized behavior for the response from the invoked API command. In the example in FIG. 3, the list at 345 contains 3 parameters, namely OK, ERROR, and NOT_FOUND, and one of the listed parameters has been selected for customizing in the interface profile, thereby replacing the normal action for the verb selected at 325. For example, suppose that the normal action in the CLOSE verb, after completing the processing of the verb and determining that an error was encountered, is to display a particular error message on a console for a network administrator and to write an error record to a log. The error message might state, for example, “Error encountered while closing network connection”. Because the customized CLOSE command processing with connection pooling does not attempt to close the network connection, it may be desirable to override this error handling. Accordingly, the software developer can select the ERROR choice (see reference number 346), and can then use the Response Actions section 350 to specify the corresponding customized behavior.

Response Actions section 350 contains selectable choices for the desired behavior for the response (i.e., output) parameter selected at 345. In the general case, this section of the interface profile provides a set of actions that can be chosen to override the normal output of the invoked API command. In the example interface profile 300, a single selected choice is illustrated, which in this example is an “OK” action. See reference number 351. A software developer might select this “OK” choice in the interface profile 300 to indicate that an “OK” message should be returned to the invoking application when the selected “ERROR” condition 346 exists—e.g., rather than returning an error message as would be done in the normal processing. Or, a choice of “OK with nulls” (not shown) might be provided, indicating that a null value should be returned to the invoking code—or perhaps that a return code indicating success, instead of indicating the error that actually occurred, should be returned. As another example (not shown), a Response Action might be specified that will automatically supply a default value for a parameter that is being returned on the invocation when the invoked function has been changed and no longer emits that parameter.

In summary, the customizations in the sample interface specification 300 illustrate that an API verb may be redefined—such that invoking the CLOSE command no longer performs a close of the network connection (see 331), and a substitution of parameter values may be defined—such as using an “OK” action 351 instead of the normal processing for an ERROR condition 346. Other customizations may be provided beyond those which have been illustrated, and several examples are discussed above, including processing that handles addition or subtraction of parameters to account for a mismatch between the number of parameters used by, or returned by, the API command and the number of parameters supplied by, or expected in return from, the invoking application.

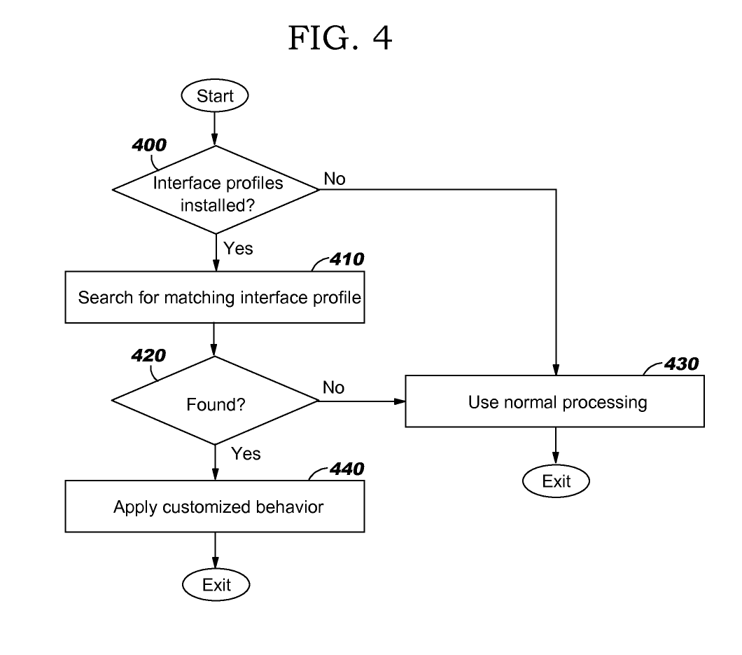

Preferably, a first matching process is performed upon receiving an invocation of an API verb and a second matching process is performed when the invocation has completed. The first matching process evaluates available interface profiles, and if the conditions for applying any of the available interface profiles are met, then customized processing specified in the matching interface profile can be used to cause different behavior to be executed for the invoked API verb, as compared to the normal processing of that API verb. The second matching process evaluates whether the output of the invoked function should be customized before returning it to the invoking application. Operation of a matching process will now be described in further detail with reference to the flowchart presented in FIG. 4.

The matching process depicted in FIG. 4 begins at Block 400 by testing whether interface profiles are installed in the system. If not, then control transfers to Block 430, which indicates that the normal processing for this invoked API command will be performed. The logic of FIG. 4 then exits.

When the test in Block 400 has a positive result (i.e., interface profiles are installed), Block 410 searches for a profile that matches the current invocation. Block 420 then tests whether a matching interface profile was found. With reference to the example interface profile 300 in FIG. 3, for example, the test at Block 420 comprises determining whether the current invocation is from an application “Appl_A” 311 that is executing a transaction “ABCD” 310.

The processing of FIG. 4 is preferably carried out by a component that executes, or dispatches for execution, the current invocation of an API verb. Thus, it may be assumed that the current invocation is of the CLOSE verb 326. Alternatively, the processing of FIG. 4 may be carried out in a more generic component which services a plurality of API commands, and in that case, the processing at Block 420 preferably further comprises determining whether an interface profile is available that meets conditions 310, 311 and that pertains to the CLOSE command 326.

When the test at Block 420 has a negative result, then none of the interface profiles matches the conditions of the current invocation. Control therefore transfers to Block 430, which indicates that the normal processing for this invoked API command will be performed. The logic of FIG. 4 then exits. Otherwise (i.e., when a matching interface profile was found), control reaches Block 440, where the customized processing indicated by the interface profile is carried out. The processing of FIG. 4 then exits.

In one approach, the processing depicted in FIG. 4 is used for both of the matching processes discussed above—that is, the first matching process performed when an API command is invoked and the second matching process performed when the invocation has completed. In an alternative approach, separate processing may be used. In the latter case, the second matching process may omit the search at Block 410 and use the interface profile which was located by the first matching process. It will be obvious to one of ordinary skill in the art, from the teachings provided herein, how the logic depicted in FIG. 4 may be adapted for this alternative approach.

It may happen, in some cases, that more than one interface profile is available for a given set of conditions. An embodiment of the present invention may be adapted for using the first-located one of these interface profiles. In an optional enhancement, an embodiment of the present invention may support evaluation of rules that resolve conflicts when more than one interface profile is available for a given set of conditions. It will be obvious to one of ordinary skill in the art, from the teachings provided herein, how the logic depicted in FIG. 4 may be adapted for this optional enhancement.

An install process may be performed for interface specifications, whereby a newly-defined interface profile is registered with the system, and the conditions (illustrated by 310, 311 in the sample of FIG. 3) for applying the profile may be evaluated and used to flag or mark a task that will be executed responsive to invocation of an API verb in the profile. This flag may then be used during the processing of FIG. 4. For example, if a request handler component is responsible for dispatching a task for carrying out the invoked API verb, the request handler may omit the processing of FIG. 4 if it is known that the task to be invoked is not flagged as having any registered interface profiles that could be applicable. (If a request handler is not used to dispatch tasks for API verbs, then an embodiment of the present invention may add a link, in the code for each task that performs an API verb, to code that performs the matching process depicted in FIG. 4.)

As has been demonstrated above, an embodiment of the present invention provides techniques for customizing API behavior with interface profiles. The interface profiles enable existing applications to continue to function, without change, when the implementation of an API verb changes but the invoking code has not been updated to match the new API. This is advantageous in a number of scenarios, examples of which are discussed above, including migration and coexistence scenarios. For example, an embodiment of the present invention may be used as an interim solution, following a change to the underlying API command processing, until invoking applications can be modified to comply with the new API. However, an implementation of the present invention may fully obviate the need for change to the invoking applications in a number of scenarios. Interface profiles provide a flexible way to customize API behavior, and one of ordinary skill in the art may envision other scenarios beyond those which have been described herein without deviating from the scope of the present invention.

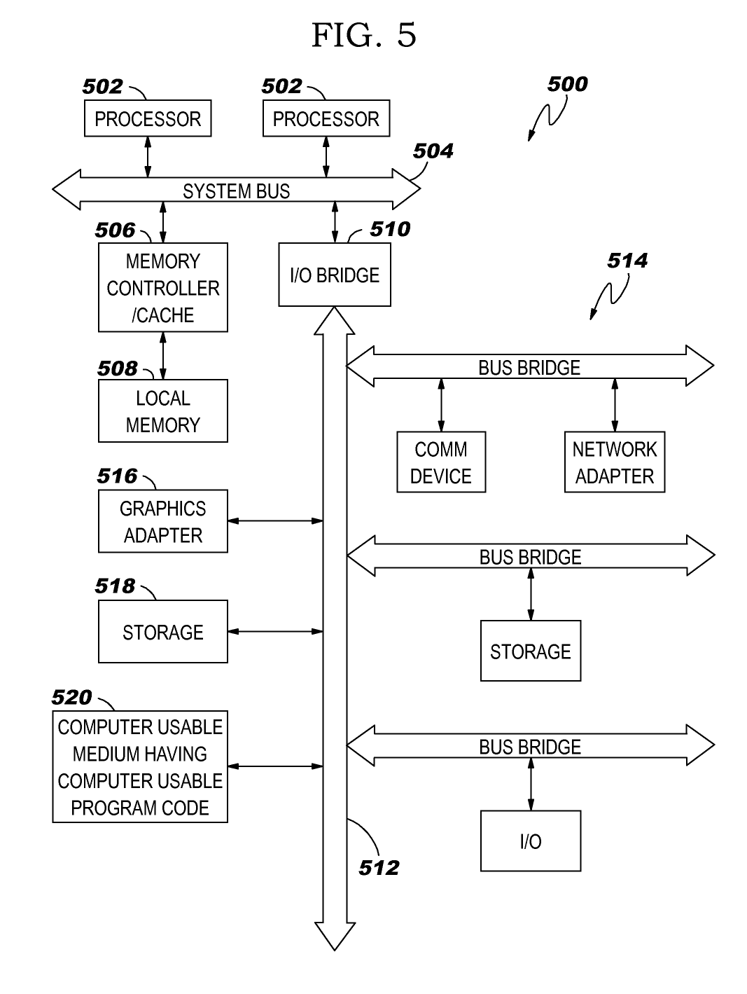

Referring now to FIG. 5, a block diagram of a data processing system is depicted in accordance with the present invention. Data processing system 500, such as one of the processing devices described herein, may comprise a symmetric multiprocessor (“SMP”) system or other configuration including a plurality of processors 502 connected to system bus 504. Alternatively, a single processor 502 may be employed. Also connected to system bus 504 is memory controller/cache 506, which provides an interface to local memory 508. An I/O bridge 510 is connected to the system bus 504 and provides an interface to an I/O bus 512. The I/O bus may be utilized to support one or more buses 514 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 516, storage 518, and a computer usable storage medium 520 having computer usable program code embodied thereon. The computer usable program code may be executed to execute any aspect of the present invention, as have been described herein.

The data processing system depicted in FIG. 5 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Oracle America, Inc., in the United States, other countries, or both.)

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including (but not limited to) an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of customizing application programming interface (“API”) behavior, comprising:
determining, for an API invocation, whether an interface profile specification is applicable for customizing behavior of the invocation; and
responsive to determining that the interface profile specification is applicable, applying the interface profile specification to customize the behavior of the invocation.

2. The method according to claim 1, wherein the applied interface profile specification is located by evaluating each of at least one condition specified in each of at least one interface profile specification and concluding that each evaluated condition in the applied profile interface specification is met.

3. The method according to claim 1, wherein:
the applied interface profile specification comprises a request specification and a response specification; and
the applying comprises applying a customization specified in at least one of the request specification and the response specification.

4. The method according to claim 3, wherein the request specification identifies an API command that is selected and at least one action that is to be performed as the customization of the behavior of the identified API command.

5. The method according to claim 4, wherein at least one of the at least one action overrides an existing behavior of the identified API command.

6. The method according to claim 3, wherein the response specification identifies an output parameter of the invocation and at least one action that is to be performed as the customization of the behavior of the identified output parameter.

7. The method according to claim 6, wherein at least one of the at least one action overrides an existing behavior of the identified output parameter.

8. The method according to claim 1, wherein the determining is performed responsive to at least one of receiving the API invocation and receiving a response from the API invocation.

9. A system for customizing application programming interface (“API”) behavior, comprising:
a computer comprising a processor; and
instructions which are executable, using the processor, to implement functions comprising:
determining, for an API invocation, whether an interface profile specification is applicable for customizing behavior of the invocation; and
responsive to determining that the interface profile specification is applicable, applying the interface profile specification to customize the behavior of the invocation.

10. The system according to claim 9, wherein the applied interface profile specification is located by evaluating each of at least one condition specified in each of at least one interface profile specification and concluding that each evaluated condition in the applied profile interface specification is met.

11. The system according to claim 9, wherein:
the applied interface profile specification comprises a request specification and a response specification; and
the applying comprises applying a customization specified in at least one of the request specification and the response specification.

12. The system according to claim 11, wherein:
the request specification identifies an API command that is selected and at least one action that is to be performed as the customization of the behavior of the identified API command; and
at least one of the at least one action overrides an existing behavior of the identified API command.

13. The system according to claim 11, wherein:
the response specification identifies an output parameter of the invocation and at least one action that is to be performed as the customization of the behavior of the identified output parameter; and
at least one of the at least one action overrides an existing behavior of the identified output parameter.

14. The system according to claim 9, wherein the determining is performed responsive to at least one of receiving the API invocation and receiving a response from the API invocation.

15. A computer program product for customizing application programming interface (“API”) behavior, the computer program product comprising:
a computer readable storage medium having computer readable program code embodied therein, the computer readable program code configured for:
determining, for an API invocation, whether an interface profile specification is applicable for customizing behavior of the invocation; and
responsive to determining that the interface profile specification is applicable, applying the interface profile specification to customize the behavior of the invocation.

16. The computer program product according to claim 15, wherein the applied interface profile specification is located by evaluating each of at least one condition specified in each of at least one interface profile specification and concluding that each evaluated condition in the applied profile interface specification is met.

17. The computer program product according to claim 15, wherein:
the applied interface profile specification comprises a request specification and a response specification; and
the applying comprises applying a customization specified in at least one of the request specification and the response specification.

18. The computer program product according to claim 17, wherein:
the request specification identifies an API command that is selected and at least one action that is to be performed as the customization of the behavior of the identified API command; and
at least one of the at least one action overrides an existing behavior of the identified API command.

19. The computer program product according to claim 17, wherein:
the response specification identifies an output parameter of the invocation and at least one action that is to be performed as the customization of the behavior of the identified output parameter; and
at least one of the at least one action overrides an existing behavior of the identified output parameter.

20. The computer program product according to claim 15, wherein the determining is performed responsive to at least one of receiving the API invocation and receiving a response from the API invocation.
